(19) United States
(12) Patent Application Publication
(10) Pub. No.: US 2010/0243530 A1
(43) Pub. Date: Sep. 30, 2010

(54) PROCESS FOR PREPARING A HYDROTREATMENT CATALYST BY IMPREGNATION WITH A PHOSPHORUS-CONTAINING COMPOUND

(75) Inventors: Karin Marchand, Lyon (FR); Mathieu Digne, Lyon (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: IFP, Rueil-Malmaison Cedex (FR)

(21) Appl. No.: 12/666,694

(22) PCT Filed: Jun. 3, 2008
(86) PCT No.: PCT/FR2008/000756

§ 371 Date: Jun. 7, 2010

(30) Foreign Application Priority Data
Jun. 25, 2007 (FR) 0704553

(51) Int. Cl. C10G 45/00; B01J 27/188; B01J 27/19; C10G 45/34

(52) U.S. Cl. 208/141; 502/210; 502/211; 208/144

(57) ABSTRACT

The invention concerns a process for preparing a hydrotreatment catalyst, comprising the following steps:
a) at least one step for impregnation of a calcined and/or dried catalytic precursor containing at least one element from group VIII and/or at least one element from group VIB and an amorphous support, using an impregnation solution constituted by at least one phosphorus-containing compound in solution in at least one polar solvent with a dielectric constant of more than 20;
b) a step for maturing said impregnated catalytic precursor from step a);
c) a step for drying, without a subsequent calcining step, said catalytic precursor from step b).

The invention relates to the field of hydrotreatment.

It principally relates to a process for preparing a catalyst for use in hydrotreatment processes, in particular in processes for hydrodesulphurization, hydrodenitrogenation, hydrodemetallization, hydrogenation and hydroconversion of oil cuts.

Normally, a catalyst for the hydrotreatment of hydrocarbon cuts is intended to eliminate sulphur-containing or nitrogen-containing compounds contained therein in order, for example, to bring an oil product up to the required specifications (sulphur content, aromatics content, etc) for a given application (automobile fuel, gasoline or gas oil, domestic fuel, jet fuel). It may also concern pre-treating that feed in order to eliminate the impurities therefrom before causing it to undergo various transformation procedures in order to modify its physico-chemical properties, for example reforming processes, hydrocracking vacuum distillates, or atmospheric or vacuum hydroconversion of residues. The composition and use of hydrotreatment catalysts are particularly well described in the article by B S Clausen, H T Topsøe and F E Massoth in the work Catalysis Science and Technology, volume 11 (1996), Springer-Verlag. After sulphurizing, several surface species are present on the support which does not perform well as regards the desired reactions. Those species are particularly well described in the publication by Topsøe et al in number 26 of the Catalysis Review, Science and Engineering, 1984, pages 395-420.

Tightening of automobile pollution standards in the European Community (European Union Official Journal, L76, 22^{nd} Mar. 2003, Directive 2003/70/CE, pages L76/10-L76/19) will constrain refiners to reduce very substantially the sulphur content of diesel fuels and gasolines (to a maximum of 10 parts per million by weight (ppm) of sulphur from 1^{st} Jan. 2009, as opposed to 50 ppm on 1^{st} Jan. 2005). Those constraints will result in a need for novel refining units or for an increase in the activity at iso-volume of hydrotreatment catalysts.

In order to improve the activity of catalysts, it is thus necessary to optimize each step of their preparation in order to have a maximum number of surface species with good hydrotreatment activity. In particular, interactions must be controlled between the support and precursors of the active phase which result in the production of refractory species as regards sulphurization (for example Al₂(MoO₄)₃, CoAl₂O₄ or NiAl₂O₄) which are of no use in the catalysis and which have undesirable effects on the catalytic activity. Those interactions between the alumina support and precursor salts in solution are known to the skilled person: Al³⁺ ions extracted from the alumina matrix can form Anderson heteropolyanions with formula [Al(OH)₆Mo₆O₁₈]³⁻ as shown by Carrier et al (Journal of the American Chemical Society 1997, 119, (42) 10137-10146). The formation of Anderson heteropolyanions is detected by Raman spectrometry at the surface of the alumina support. Further, for high molybdenum contents, phases which are refractory to sulphurization may form by sintering to the surface of the catalyst, such as the phases CoMoO₄ or CO₃O₄ (B S Clausen, H T Topsøe, F E Massoth, in the publication Catalysis Science and Technology, volume 11 (1996), Springer-Verlag).

In order to increase the activity of hydrotreatment catalysts, it thus transpires that it is important to have better control of the various steps in the preparation of the hydrotreatment catalysts, in particular the interactions between the support and the precursors of the active phase. Hence, compared with catalysts which are fabricated conventionally using ammonium heptamolybdate and cobalt or nickel nitrate, one solution to preventing the formation of [Al(OH)₆Mo₆O₁₈]³⁻ may be to use phosphomolybdic heteropolyanions. They are traditionally obtained by introducing phosphoric acid for co-impregnation with the precursors of the active phase. The molybdenum is protected by the formation of phosphomolybdic heteropolyanions which are more stable than the heteropolyanion [Al(OH)₆Mo₆O₁₈]³⁻.

Further, it is known to the skilled person that catalysts doped with phosphorus have better catalytic activity. Keggin type heteropolyanions PMo₁₂O₄₀³⁻, PCoMo₁₁O₄₀⁷⁻, as well as the heteropolyanion P₂Mo₅O₂₃⁶⁻ are now routinely used for catalyst preparation. It has thus been shown, in the Journal of the American Chemical Society 2004, 126 (44), 14548-14556 that the use of the heteropolyanion P₂Mo₅O₂₃⁶⁻ is particularly advantageous. That heteropolyanion is obtained for P/Mo molar ratios in the impregnation solution of 0.4 or more.

However, introducing phosphoric acid into impregnation solutions, as well as the weak pH of the heteropolyanionic solutions, causes a more important phenomenon of partial dissolution of the support. This results in a degradation of the textural parameters, in particular a reduction in the BET specific surface area for the final catalyst (see Applied Catalysis 56 (1989), 197-206, in particular page 202). However, such a reduction is deleterious to the dispersion of the active phase precursors on the support surface, which may result in the formation, by sintering, of refractory phases CoMoO₄ (respectively NiMoO₄) and CO₃O₄ (respectively NiO) during any calcining.

A similar phenomenon can be observed with phosphotungstic heteropolyanions.

Thus, it is appears to be advantageous to discover means for preparing hydrotreatment catalysts in general, and in particular CoMoP or NiMoP catalysts which are different from the existing means.

Intevep's U.S. Pat. No. 4,743,574 proposes a solution consisting of initially introducing all of the phosphorus into the support. The patent describes a method for the preparation of a catalyst for hydrodesulphurization and hydrodenitrogenation containing an aluminophosphate or aluminoborate support and which allows a reduced cobalt content to be employed. By using a support based on aluminophosphate (or aluminoborate), i.e. by adding small quantities of phosphorus in the form of P₂O₅ (or boron in the form of B₂O₃) to the alumina before depositing the metals constituting the active phase on the support, the interactions between said metals and the alumina are reduced, which allows the quantity of metal constituting the active phase employed, in particular the quantity of cobalt, to be reduced without a loss of catalytic activity. However, forming such supports is difficult because of the desiccating properties of the phosphoric anhydride (P₂O₅) and the BET surface of the final catalyst cannot be improved, which causes a reduction in the dispersion of the precursors of the active phase at the surface of the support.

One advantage of the invention is the provision of a process for preparing a hydrotreatment catalyst which allows phosphorus to be introduced in the form of a phosphorus-containing compound using a step for impregnation of a dried and/or calcined catalytic precursor containing at least one element from group VIII and/or at least one element from group VIB and an amorphous support, said hydrotreatment catalyst obtained having better catalytic activity compared with prior art catalysts.

Another advantage of the present invention is the provision of a process for preparing a hydrotreatment catalyst allowing the introduction of a non negligible quantity of phosphorus in the form of a phosphorus-containing compound by a step for impregnating a dried and/or calcined catalytic precursor containing at least one element from group VIII and/or at least one element from group VIE and an amorphous support, while maintaining the specific surface area, calculated in m² per gram of alumina, between the starting dried and/or calcined catalytic precursor and the final catalyst obtained by the process of the invention.

In the context of the invention, a process which overcomes the problems cited above has now been discovered; in contrast to the prior art, it allows any reduction in the BET specific surface area to be moderated. The present invention describes a process for preparing a hydrotreatment catalyst, comprising the following steps:
a) at least one step for impregnation of a dried and/or calcined catalytic precursor containing at least one element from group VIII and/or at least one element from group VIB and an amorphous support, using an impregnation solution constituted by at least one phosphorus-containing compound in solution in at least one polar solvent with a dielectric constant of more than 20;
b) a step for maturing said impregnated catalytic precursor from step a);
c) a step for drying, without a subsequent calcining step, said catalytic precursor from step b).

Without wishing to be bound by any particular theory, it is probable that the process of the invention, because of its step a), can allow at least one impregnation of a catalytic precursor already containing at least one element from group VIII and/or VIB and an amorphous support, preferably alumina, using an impregnation solution constituted by at least one phosphorus-containing compound in solution in at least one polar solvent with a dielectric constant of more than 20, which can avoid direct contact of the amorphous support, preferably alumina, with said phosphorus-containing compound. The process of the invention can thus avoid the phenomenon of dissolution of the amorphous support, preferably alumina, in the presence of a phosphorus-containing compound, thereby avoiding a reduction in the BET specific surface area.

The dried and/or calcined catalytic precursor containing at least one element from group VIII and/or at least one element from group VIB and an amorphous support used in step a) of the process of the invention and its mode of preparation are described below.

Said catalytic precursor used in step a) of the process of the invention may be prepared for the most part using methods which are well known to the skilled person.

Said catalytic precursor contains a hydrodehydrogenating function constituted by at least one element from group VIII and/or at least one element from group VIB and optionally contains phosphorus and/or silicon as a dopant, and an amorphous support.

The amorphous support for said catalytic precursor which is generally used is selected from the group formed by alumina and silica-alumina.

In the case in which the amorphous support is silica-alumina, said amorphous support preferably contains at least 40% by weight of alumina.

Preferably, said amorphous support is constituted by alumina and highly preferably, by gamma alumina.

In the case in which the amorphous support is alumina, said amorphous support is advantageously shaped as follows: a matrix constituted by a moist alumina gel such as hydrated aluminium oxyhydroxide, is mixed with an aqueous acidic solution such as a solution of nitric acid, for example, then milled. This is peptization. Following milling, the paste obtained is passed through a die to form extrudates with a diameter which is preferably in the range 0.4 to 4 mm. The extrudates then undergo a drying step at a drying temperature in the range 80° C. to 150° C. Shaping of said amorphous support is then advantageously followed by a calcining step carried out at a calcining temperature in the range 300° C. to 600° C.

The hydrodehydrogenating function of said catalytic precursor is provided by at least one metal from group VIB of the periodic table of the elements selected from molybdenum and tungsten, used alone or as a mixture, and/or by at least one metal from group VIII of the periodic table of the elements selected from cobalt and nickel, used alone or as a mixture.

The total quantity of hydrodehydrogenating elements from groups VIB and/or VIII is advantageously more than 2.5% by weight of oxide with respect to the total catalyst weight.

In the case in which a high hydrodesulphurization activity is desired, the metals of the hydrodehydrogenating function advantageously consist of a combination of cobalt and molybdenum; if a high hydrodenitrogenation activity is desired, a combination of nickel and molybdenum or tungsten is preferred.

The precursors of the group VIB elements which may be used are well known to the skilled person. As an example, sources of molybdenum and tungsten which may be used include oxides and hydroxides, molybdic and tungstic acids and their salts, in particular ammonium salts such as ammonium molybdate, ammonium heptamolybdate, ammonium tungstate, phosphomolybdic acid, phosphotungstic acid and salts thereof. Preferably, molybdenum trioxide or phosphotungstic acid is used.

The quantities of precursors of the element from group VIB are advantageously in the range 5% to 35% by weight of oxides with respect to the total mass of the catalytic precursor, preferably in the range 15% to 30% by weight, and more preferably in the range 16% to 29% by weight.

The precursors of the group VIII elements which may be used are advantageously selected from oxides, hydroxides, hydroxycarbonates, carbonates and nitrates of elements from group VIII. In the case in which the element from group VIII employed is cobalt, cobalt hydroxide and cobalt carbonate are preferably used. In the case in which the element from group VIII employed is nickel, nickel hydroxycarbonate is preferably used.

The quantities of precursors of the elements from group VIII are advantageously in the range 1% to 10% by weight of oxides with respect to the total mass of catalytic precursor, preferably in the range 1.5 to 9% by weight and more preferably in the range 2% to 8% by weight.

The hydrodehydrogenating function of said catalytic precursor may advantageously be introduced into the catalyst at various stages of the preparation and in various manners.

Said hydrodehydrogenating function may advantageously be introduced at least in part during shaping of said amorphous support or, as is preferable, after said shaping.

In the case in which the hydrodehydrogenating function is introduced at least in part during shaping of said amorphous support, it may advantageously be introduced in part only at the moment of milling with an oxide gel selected as a matrix, the remainder of the hydrogenating element(s) then being introduced after milling, and preferably after calcining the pre-shaped support. Said hydrodehydrogenating function may also advantageously be introduced in its entirety at the moment of milling with the gel of the oxide selected as a matrix.

Preferably, the metal from group VIB is introduced at the same time or just after the metal from group VIII, regardless of the mode of introduction.

In the case in which the hydrodehydrogenating function is introduced at least in part and preferably in its entirety after shaping said amorphous support, the introduction of said hydrodehydrogenating function onto the amorphous support may advantageously be carried out using one or more impregnations of excess solution onto the shaped and calcined support, or as is preferable by one or more dry impregnations, and highly preferably by a dry impregnation of said support which has been shaped and calcined, using solutions containing the precursor salts of the metals. Preferably, the hydrodehydrogenating function is introduced in its entirety after shaping said amorphous support, by dry impregnation of said support using an impregnation solution containing precursor salts of the metals. Said hydrodehydrogenating function may also advantageously be introduced by one or more impregnations of the support which has been shaped and calcined, using a solution of the precursor(s) of the oxide of the metal from group VIII when the precursor(s) of the oxides of the metal from group VIB has/have already been introduced when milling the support. In the case in which the elements are introduced in a number of impregnations of the corresponding precursor salts, an intermediate calcining step for the catalyst is generally carried out at a temperature in the range 250° C. to 500° C.

A dopant for the catalyst selected from phosphorus, boron, fluorine and silicon, used alone or as a mixture, preferably with said dopant being phosphorus, may also advantageously be introduced. Said dopant may advantageously be introduced alone or as a mixture with the metal or metals from group VIB and/or group VIII. It may advantageously be introduced just before or just after peptizing the selected matrix, such as, for example and preferably, the aluminium oxyhydroxide (boehmite) precursor of alumina. Said dopant may also advantageously be introduced as a mixture with the metal from group VIB or the metal from group VIII, completely or partially onto the shaped amorphous support (preferably alumina in the extruded form) by means of dry impregnation of said amorphous support using a solution containing the precursor salts of the metals and the dopant precursor.

Many sources of silicon may be used. Thus, it is possible to use ethyl orthosilicate Si(OEt)₄, silanes, polysilanes, siloxanes, polysiloxanes, halogen silicates such as ammonium fluorosilicate (NH₄)₂SiF₆ or sodium fluorosilicate Na₂SiF₆. Silicomolybdic acid and its salts, or silicotungstic acid and its salts may also advantageously be used. The silicon may, for example, be added by impregnating ethyl silicate in solution in a water/alcohol mixture. The silicon may, for example, be added by impregnation of a polyalkylsiloxane type silicon compound in suspension in water.

The source of boron may be boric acid, preferably orthoboric acid, H₃BO₃, ammonium biborate or pentaborate, boron oxide, or boric esters. The boron may, for example, be introduced in the form of a boric acid solution in a water/alcohol mixture or in a water/ethanolamine mixture.

The preferred source of phosphorus is orthophosphoric acid H₃PO₄, but its salts and esters such as ammonium phosphates are also suitable.

The sources of fluorine which may be used are well known to the skilled person. As an example, the fluoride anions may be introduced in the form of hydrofluoric acid or salts thereof. Said salts are formed with alkali metals, ammonium or an organic compound. In this latter case, the salt is advantageously formed in the reaction mixture by reaction between the organic compound and hydrofluoric acid. It is also possible to use hydrolysable compounds which can liberate fluoride anions into the water, such as ammonium fluorosilicate (NH₄)₂SiF₆, sodium fluorosilicate Na₂SiF₆ or silicon tetrafluoride SiF₄ or. The fluorine may, for example, be introduced by impregnation of an aqueous solution of hydrofluoric acid, ammonium fluoride or ammonium difluoride.

The dopant is advantageously introduced into the catalytic precursor in a quantity of the oxide of said dopant in the range 0.1% to 40%, preferably 0.1% to 30% and more preferably in the range 0.1% to 20% when said dopant is selected from boron and silicon (the % being expressed as the % by weight of oxides).

The dopant may also advantageously be introduced into the catalytic precursor in a quantity of the oxide of said dopant in the range 0 to 20%, preferably 0.1% to 15% and more preferably 0.1% to 10%, when said dopant is phosphorus (the % being expressed as a % by weight of oxides).

The dopant may also advantageously be introduced into the catalytic precursor in a quantity of the oxide of said dopant in the range 0 to 20%, preferably 0.1% to 15% and more preferably in the range 0.1% to 10% when said dopant is fluorine (the % being expressed as the % of oxides).

The introduction of said hydrodehydrogenating function and optional dopant for the catalyst into or onto the shaped and calcined support is then advantageously followed by a step for drying during which the solvent for the metallic salts, precursors for the metal oxide(s), (generally water) is eliminated, at a temperature in the range 50° C. to 150° C.

The step for drying the catalytic precursor obtained thereby is then optionally followed by a step for calcining in air, at a temperature in the range 200° C. to 500° C., said calcining step being intended to structure the oxide phase of the catalytic precursor obtained and to increase the stability of said catalytic precursor and thus its lifetime in the unit.

Finally, it should be noted that this list is not limiting, since a large number of variations can be employed.

In accordance with a preferred implementation of the process for preparing the catalytic precursor used in step a) of the process of the invention, said catalytic precursor is obtained by impregnation of a solution of the precursor(s) of the oxide of the metal from group VIII and/or the precursor(s) of the oxides of the metal from group VIB onto a shaped and calcined support, followed by drying at a drying temperature in the range 50° C. to 150° C. The catalytic precursor obtained is thus a dried catalytic precursor.

In accordance with a highly preferred implementation of the process for preparing a catalytic precursor used in step a) of the process of the invention, the impregnation solution described above also contains at least one dopant selected from phosphorus and silicon, used alone or as a mixture.

In accordance with another preferred implementation of the process for preparing the catalytic precursor used in step a) of the process of the invention, said catalytic precursor is obtained by impregnation of a solution of the precursors) of the oxide of the metal from group VIII and/or the precursor(s) of the oxides of the metal from group VIB onto a shaped and calcined support, followed by drying at a drying temperature in the range 50° C. to 150° C. and calcining in air at a temperature in the range 200° C. to 500° C. The catalytic precursor obtained is thus a calcined catalytic precursor.

In accordance with another highly preferred implementation of the process for preparing a catalytic precursor used in step a) of the process of the invention, the impregnation solution described above also contains at least one dopant selected from phosphorus and silicon, used alone or as a mixture.

The dried and/or calcined catalytic precursor obtained thereby is then used in step a) of the process of the invention.

In accordance with step a) of the process of the invention, the dried and/or calcined catalytic precursor contains at least one element from group VIII and/or at least one element from group VIB and an amorphous support.

In accordance with a preferred implementation of step a) of the preparation process of the invention, said dried and/or calcined catalytic precursor contains at least one element from group VIII, selected from cobalt and nickel, used alone or as a mixture, and/or at least one element from group VIB selected from molybdenum and tungsten, used alone or as a mixture, at least one dopant selected from the group formed by phosphorus and silicon, used alone or as a mixture, and an amorphous support selected from alumina and silica-alumina.

In accordance with a highly preferred implementation of step a) of the preparation process of the invention, said dried and/or calcined catalytic precursor contains at least one element from group VIII, said element from group VIII being cobalt, and at least one element from group VIB, said element from group VIB being molybdenum, with phosphorus as a dopant, and an amorphous alumina support.

In accordance with another highly preferred implementation of step a) of the preparation process of the invention, said dried and/or calcined catalytic precursor contains at least one element from group VIII, said element from group VIII being nickel, and at least one element from group VIB, said element from group VIB being molybdenum, with phosphorus as a dopant, and an amorphous alumina support.

In accordance with another highly preferred implementation of step a) of the preparation process of the invention, said dried and/or calcined catalytic precursor contains at least one element from group VIII, said element from group VIII being nickel, and at least one element from group VIB, said element from group VIB being tungsten, with phosphorus as a dopant, and an amorphous alumina support.

In accordance with step a) of the process of the invention, said dried and/or calcined catalytic precursor is impregnated with an impregnation solution constituted by at least one phosphorus-containing compound in solution in at least one polar solvent with a dielectric constant of more than 20.

The phosphorus-containing compound of the impregnation solution of step a) of the process of the invention is advantageously selected from the group formed by orthophosphoric acid H₃PO₄, metaphosphoric acid and phosphorus pentoxide or phosphoric anhydride P₂O₅ or P₄O₁₀, used alone or as a mixture; preferably, said phosphorus-containing compound is orthophosphoric acid H₃PO₄.

The phosphorus-containing compound of the impregnation solution of step a) of the process of the invention may also advantageously be selected from the group formed by dibutylphosphate, triisobutyl phosphate, phosphate esters and phosphate ethers, used alone or as a mixture.

The phosphorus-containing compound of the impregnation solution of step a) of the process of the invention may also advantageously be selected from the group formed by ammonium phosphate NH₄H₂PO₄, diammonium phosphate (NH₄)₂H₂PO₄, and ammonium polyphosphate (NH₄)₄P₂O₇, used alone or as a mixture.

Said phosphorus-containing compound is advantageously introduced into the impregnation solution of step a) of the process of the invention in a quantity corresponding to a molar ratio of phosphorus P to the metal (metals) of group VIB of said catalytic precursor in the range 0.001 to 3 mole/mole, preferably in the range 0.005 to 2 mole/mole, preferably in the range 0.005 to 1 mole/mole and more preferably in the range 0.01 to 1 mole/mole.

In accordance with step a) of the process of the invention, the phosphorus-containing compound is introduced onto the dried and/or calcined catalytic precursor by at least one impregnation step, preferably by a single step for impregnation of an impregnation solution onto said dried and/or calcined compound precursor described above.

Said phosphorus-containing compound may advantageously be deposited either by slurry impregnation, or by excess impregnation, or by dry impregnation or by any other means known to the skilled person.

In accordance with a preferred implementation of step a) of the preparation process of the invention, step a) is a single dry impregnation step.

In accordance with step a) of the process of the invention, the impregnation solution of step a) is constituted by at least one phosphorus-containing compound, preferably a single phosphorus-containing compound in solution in at least one polar solvent with a dielectric constant of more than 20.

In the case in which said impregnation solution of step a) of the process of the invention is constituted by at least one phosphorus-containing compound in solution in more than one polar solvent, i.e. in a mixture of polar solvents, each of the solvents constituting the mixture of polar solvents advantageously having a dielectric constant of more than 20, preferably more than 24.

In accordance with a first preferred implementation of step a) of the process of the invention, said impregnation solution is constituted by at least one phosphorus-containing compound, preferably a single phosphorus-containing compound in solution in a single polar solvent with a dielectric constant of more than 20.

Highly preferably, said impregnation solution is constituted by at least one phosphorus-containing compound, preferably a single phosphorus-containing compound in solution in a single polar solvent with a dielectric constant of more than 24.

In accordance with a second preferred implementation of step a) of the process of the invention, said impregnation solution is constituted by at least one phosphorus-containing compound, preferably a single phosphorus-containing compound in solution in a mixture of two polar solvents, each of the two polar solvents having a dielectric constant of more than 20.

Highly preferably, said impregnation solution is constituted by at least one phosphorus-containing compound, preferably a single phosphorus-containing compound in solution in two polar solvents, each of the two polar solvents having a dielectric constant of more than 24.

In accordance with a third preferred implementation of step a) of the process of the invention, said impregnation solution is solely constituted by at least one phosphorus-containing compound, preferably a single phosphorus-containing compound in solution in at least one polar solvent, free of metals, having a dielectric constant of more than 20.

Preferably, said impregnation solution is solely constituted by at least one phosphorus-containing compound, preferably solely a single phosphorus-containing compound in solution in a single polar solvent, free of metals, with a dielectric constant of more than 20.

Highly preferably, said impregnation solution is solely constituted by at least one phosphorus-containing compound, preferably solely a single phosphorus-containing compound in solution in a mixture of two polar solvents, free of metals, each of the two polar solvents having a dielectric constant of more than 20.

In accordance with a more preferred third implementation of step a) of the process of the invention, said impregnation solution is solely constituted by at least one phosphorus-containing compound, preferably a single phosphorus-containing compound in solution in at least one polar solvent, free of metals, having a dielectric constant of more than 24.

Preferably, said impregnation solution is solely constituted by at least one phosphorus-containing compound, preferably solely a single phosphorus-containing compound in solution in a single polar solvent, free of metals, with a dielectric constant of more than 24.

Highly preferably, said impregnation solution is solely constituted by at least one phosphorus-containing compound, preferably solely a single phosphorus-containing compound in solution in a mixture of two polar solvents, free of metals, each of the two polar solvents having a dielectric constant of more than 24.

Said polar solvent used in step a) of the process of the invention is advantageously selected from the group of polar protic solvents selected from methanol, ethanol, water, phenol, cyclohexanol and 1,2-ethanediol, used alone or as a mixture.

Said polar solvent used in step a) of the process of the invention may also advantageously be selected from the group formed by propylene carbonate, DMSO (dimethylsulphoxide) and sulpholane, used alone or as a mixture.

Preferably, a polar protic solvent is used.

A list of the usual polar solvents and their dielectric constants can be found in the book “Solvents and Solvent Effects in Organic Chemistry”, C Reinhardt, Wiley-VCH, 3rd edition, 2003, pages 472-474).

In accordance with a preferred implementation of step a) of the preparation process of the invention, it is possible to carry out several successive impregnation steps using an impregnation solution constituted by at least one phosphorus-containing compound, preferably a single phosphorus-containing compound in solution in a suitable polar solvent as defined above.

In accordance with step b) of the preparation process of the invention, the impregnated catalytic precursor derived from impregnation step a) undergoes a maturation step which is of particular importance to the invention. Step b) for maturation of said impregnated catalytic precursor from step a) is advantageously carried out at atmospheric pressure and at a temperature in the range from ambient temperature to 60° C. and for a maturation period in the range 12 hours to 340 hours, preferably in the range 24 hours to 170 hours. The maturation period is advantageously a function of the temperature at which this step is carried out. One means of verifying that the maturation period is sufficient is to characterize the distribution of phosphorus in the impregnated catalytic precursor derived from step a) of the process of the invention, using techniques such as a Castaing microprobe, providing a distribution profile for the various elements, transmission electron microscopy coupled to X ray analysis of the catalyst components, or by mapping the distribution of the elements present in the catalyst using an electronic microprobe. In particular, when maturation is too short, the phosphorus will be distributed in the crust of said catalytic precursor when it contains phosphorus.

In accordance with step c) of the preparation process of the invention, the catalytic precursor from step b) undergoes a drying step, without a subsequent step for calcining said catalytic precursor from step b).

The aim of this step is to advantageously remove all or part of the solvent which has allowed said phosphorus-containing compound to be introduced. Drying step c) of the process of the invention is advantageously carried out using any technique which is known to the skilled person. Drying step c) of the process of the invention is advantageously carried out in an atmospheric pressure or reduced pressure furnace and at a temperature in the range 50° C. to 200° C., preferably in the range 60° C. to 190° C., and more preferably in the range 60° C. to 150° C., for a drying period in the range 30 minutes to 4 hours, preferably in the range 1 hour to 3 hours. Drying may advantageously be carried out in a traversed bed using air or any other hot gas. Preferably, when drying is carried out in a fixed bed, the gas employed is either air or an inert gas such as argon or nitrogen.

At the end of step c) of the process of the invention, a dried catalyst is obtained which does not undergo any subsequent calcining steps.

Before its use, it is advantageous to transform a catalyst in which the metals are in an oxide form into a sulphide catalyst in order to form its active species. This activation or sulphurization phase is advantageously carried out in a sulpho-reductive atmosphere in the presence of hydrogen and hydrogen sulphide using methods which are well known to the skilled person.

At the end of step c) of the process of the invention, said dried catalyst obtained advantageously undergoes a sulphurization step d), with no intermediate calcining step.

Said dried catalyst obtained at the end of step c) of the process of the invention is advantageously sulphurized ex situ or in situ. The sulphurizing agents are advantageously the gas H₂S or any other sulphur-containing compound used for activation of hydrocarbon feeds with a view to sulphurizing the catalyst. Said sulphur-containing compounds are advantageously selected from alkyldisulphides such as dimethyldisulphide, for example, alkylsulphides, such as dimethylsulphide, for example, n-butyl mercaptan, polysulphide compounds of the tertio-nonylpolysulphide type, such as TPS-37 or TPS-54 sold by ARKEMA, for example, or any other compound which is known to the skilled person which can achieve good sulphurization of the catalyst.

The dried catalysts obtained by the process of the invention and which have undergone a sulphurization step d) are advantageously used for hydrorefining and hydroconversion of hydrocarbon feeds such as oil cuts, cuts from coal or hydrocarbons produced from natural gas, more particularly for hydrogenation, hydrodenitrogenation, hydrodeoxygenation, hydrodearomatization, hydrodesulphurization, hydrodemetallization and hydroconversion of hydrocarbon feeds containing aromatic and/or olefinic and/or naphthenic and/or paraffinic compounds, said feeds optionally containing metals and/or nitrogen and/or oxygen and/or sulphur. In these uses, the catalysts obtained by the process of the invention and which may have undergone a prior sulphurization step d) have an improved activity over prior art catalysts.

The amorphous dried catalysts obtained by the process of the invention which have already undergone a sulphurization step d) may also advantageously be used for hydrocracking reactions.

More particularly, the feeds employed in the processes using reactions for hydrorefining and hydroconversion of hydrocarbon feeds as described above are advantageously gasolines, gas oils, vacuum gas oils, atmospheric residues, vacuum residues, atmospheric distillates, vacuum distillates, heavy fuels, oils, waxes and paraffins, spent oils, deasphalted residues or crudes, or feeds from thermal or catalytic conversion processes, used alone or as a mixture. They advantageously contain heteroatoms such as sulphur, oxygen or nitrogen and/or at least one metal.

The operating conditions used in processes employing reactions for hydrorefining and hydroconversion of hydrocarbon feeds as described above are generally as follows: the temperature is advantageously in the range 180° C. to 450° C., preferably in the range 250° C. to 440° C., the pressure is advantageously in the range 0.5 to 30 MPa, preferably in the range 1 to 18 MPa, the hourly space velocity is advantageously in the range 0.1 to 20 h⁻¹, preferably in The range 0.2 to 5 h⁻¹, and the hydrogen/feed ratio, expressed as the volume of hydrogen measured under normal temperature and pressure conditions, per volume of liquid feed is advantageously in the range 50 l/l to 2000 l/l.

The dried catalysts obtained by the process of the invention and which optionally may have undergone a prior sulphurization step d) may also advantageously be used during pre-treatment of the catalytically cracked feeds and in the first step of a hydrocracking or mild hydroconversion. They are thus generally employed upstream of an acidic, zeolitic or non zeolitic catalyst used in the second step of the treatment.

The following examples demonstrate the substantial gain in activity for catalysts prepared using the process of the invention over prior art catalysts and serve to illustrate the invention without in any way limiting its scope, however.

### EXAMPLES

For all of the examples of preparations of the catalysts of the present invention, an alumina was used as the support.

### Example 1

### Preparation of a Dried Catalyst C1′ and of a Calcined Catalyst C1′ of the CoMoP Type (not in Accordance with the Invention)

A matrix composed of ultrafine tabular boehmite or alumina gel sold under the trade name SB3 by Condea Chemie GmbH was used. This gel was mixed with an aqueous solution containing 66% nitric acid (7% by weight of acid per gram of dry gel), then milled for 15 minutes. At the end of milling, the paste obtained was passed through a die having cylindrical orifices with a diameter of 1.6 mm. The extrudates were then dried overnight at 120° C., then calcined at 540° C. for 2 hours in moist air containing 40 g of water per kg of dry air. Cylindrical extrudates 1.2 mm in diameter were thus obtained, with a specific surface area of 300 m²/g, a pore volume of 0.70 cm³/g and a monomodal pore size distribution centred on 93 Å. Analysis of the matrix by X ray diffraction revealed that it was solely composed of low crystallinity cubic gamma alumina.

Cobalt, molybdenum and phosphorus were added to the alumina support described above which was in the “extrudate” form (67.9 g). The impregnation solution was prepared by hot dissolution of molybdenum oxide (24.34 g) and cobalt hydroxide (5.34 g) in the phosphoric acid solution (7.47 g) in aqueous solution (V=57.0 cm³). After dry impregnation, the extrudates were allowed to mature in a water-saturated atmosphere for 12 h, then dried overnight at 120° C. the dried catalyst obtained was the catalyst Cr. Finally, calcining the catalyst C1′ at 450° C. for 2 hours in dry air produced the calcined catalyst C1. The final oxide contents of the metals and the specific surface area of catalysts C1′ and C1 (determined using the BET method which is well known to the skilled person) were thus as follows:

| | |
|---|---|
| MoO₃: | 23.4 (% by weight); |
| CoO: | 4.1 (% by weight); |
| P₂O₅: | 4.6 (% by weight); |
| specific surface area (S_{BET}): | 180 (m²/g of catalyst), i.e. 273 m²/g |
| | of alumina in catalyst C1; |
| Ptotal/Mo | 0.563 mol/mol. |

### Example 2

### Preparation of a Dried Catalyst C2′ and of a Calcined Catalyst C2 of the CoMoP Type (not in Accordance with the Invention)

Catalyst C2 was prepared in the same manner as calcined catalyst C1, from shaped alumina (70.7 g), molybdenum trioxide (24.23 g), cobalt hydroxide (5.21 g) and a smaller quantity of phosphoric acid (3.25 g).

As with Example 1, catalyst C2′ corresponded to the dried catalyst obtained after the drying step. The final quantities of metals and the specific surface area of catalysts C2′ and C2 were thus as follows:

| | |
|---|---|
| MoO₃: | 23.3 (% by weight); |
| CoO: | 4.0 (% by weight); |
| P₂O₅: | 2.0 (% by weight); |
| specific surface area (S_{BET}): | 203 (m²/g of catalyst), i.e. 287 m²/g of |
| | alumina present in catalyst C2; |
| Ptotal/Mo | 0.174 mol/mol |

It should be noted that a smaller quantity of phosphorus in the impregnation solution could produce a calcined catalyst C2 with a higher BET specific surface area than that of calcined catalyst C1. This tendency is more marked when the BET specific surface area is expressed in g of alumina present in the catalyst.

### Example 3

### Preparation of a Dried Catalyst C3′ and of a Calcined Catalyst C3 of the CoMo Type (not in Accordance with the Invention)

Catalyst C3 was prepared in the same manner as calcined catalysts C1 and C2, but using a different impregnation solution, based on heteropolyanions of the CO₂Mo₁₀O₃₈H₄⁶⁻ type. The preparation of such impregnation solutions is described in patent application EP 1 393 802 A1. As with Examples 1 and 2, catalyst C3′ corresponded to the dried catalyst obtained after the drying step. The final quantities of metals and the specific surface area of catalysts C3′ and C3 were thus as follows:

| | |
|---|---|
| MoO₃: | 23.0 (% by weight); |
| CoO: | 5.3 (% by weight); |
| specific surface area (S_{BET}): | 214 (m²/g of catalyst), i.e. 298 m²/g of |
| | alumina in catalyst C3; |
| Ptotal/Mo | 0 mol/mol |

It should be noted that this catalyst contained no phosphorus in its impregnation solution and had a specific surface area which was even higher than that of C2 and, clearly, than that of C1.

### Example 4

### Preparation of a Catalyst C4 and a Catalyst C4′ by Impregnation of Calcined Catalyst C1 and Dried Catalyst C1′ Respectively (in Accordance with the Invention)

Catalyst C4 (respectively catalyst C4′) was obtained by impregnation, in accordance with step a) of the process of the invention, of calcined CoMoP catalyst C1 (respectively of dried catalyst C1′) such that the quantity of phosphorus introduced during this impregnation step was 0.05 (mol of P)/(mol of Mo present on the calcined C1 and dried C1′ catalytic precursors). The phosphorus precursor used was phosphoric acid dissolved in a polar solvent constituted by a 50/50 by volume water/ethanol mixture, each of the constituents of said mixture having a dielectric constant of more than 20 (the dielectric constant of water is 78.4 and the dielectric constant of ethanol is 24.5). After a maturation step of 48 h, the extrudates were dried at 120° C. for 2 h at a pressure of 100 mbar. The final metal oxide contents, the specific surface area of the catalysts C4 and C4′ and the molar ratio of the total phosphorus to the metals, Pₜₒₜₐₗ/Mo deposited in the calcined C4 and dried C4′ catalysts were thus as follows:

| | |
|---|---|
| MoO₃: | 23.3 (% by weight); |
| CoO: | 4.1 (% by weight); |
| P₂O₅: | 5.1 (% by weight) |
| specific surface area (S_{BET}): | 179 (m²/g of catalyst), i.e. 273 m²/g of |
| | alumina in catalyst C4; |
| Pₜₒₜₐₗ/Mo | 0.613 mol/mol |

It should be noted that this catalyst contained more phosphorus, but its BET specific surface area was only slightly modified by adding the phosphorus by impregnation of a solution onto catalysts C1 and C1′ in accordance with step a) of the process of the invention.

### Example 5

### Preparation of a Catalyst C5 and a Catalyst C5′ by Impregnation of Calcined Catalyst C2 and Dried Catalyst C2′ Respectively (in Accordance with the Invention)

Catalyst C5 (respectively catalyst C5′) was obtained by impregnation in accordance with step a) of the process of the invention of calcined CoMoP catalyst C2 (respectively of dried catalyst C2′) such that the quantity of phosphorus introduced during this impregnation step was 0.44 (mol of P)/(mol of Mo present on the calcined C2 and dried C2′ catalytic precursors). The molar ratio of the total phosphorus over the metals, Pₜₒₜₐₗ/Mo, deposited into the calcined C4 and C5 and dried C4′ and C5′ catalysts were thus identical, i.e. equal to 0.613 (mol of P)/(mol of Mo). The phosphorus precursor used was phosphoric acid dissolved in a polar solvent constituted by a 50/50 by volume water/ethanol mixture, each of the constituents of said mixture having a dielectric constant of more than 20 (the dielectric constant of water is 78.4 and the dielectric constant of ethanol is 24.5). After a maturation step of 48 h, the extrudates were dried at 120° C. for 2 h at a pressure of 100 mbar. The final metal oxide contents, the specific surface area of the catalysts C5 and C5′ and the molar ratio of the total phosphorus to the metals, Pₜₒₜₐₗ/Mo, deposited in the calcined C4 and dried C4′ catalysts were thus as follows:

| | |
|---|---|
| MoO₃: | 22.6 (% by weight); |
| CoO: | 3.9 (% by weight); |
| P₂O₅: | 5.0 (% by weight) |
| specific surface area (S_{BET}): | 193 (m²/g of catalyst), i.e. 287 m²/g of |
| | alumina in catalyst C5; |
| Pₜₒₜₐₗ/Mo | 0.614 mol/mol |

It should be noted that these catalysts have the same final formulation as catalysts C4 and C4′ except that a larger quantity of phosphorus had been introduced in step a) of the process of the invention. Its specific surface area was higher than that of catalyst C4, in particular when this specific surface area is expressed in grams of alumina present in the catalyst.

### Example 6

### Preparation of a Catalyst C6 and a Catalyst C6′ by Impregnation of Catalyst C3 and Catalyst C3′ Respectively (in Accordance with the Invention)

Catalyst C6 (respectively catalyst C6′) was obtained by impregnation in accordance with step a) of the process of the invention of CoMo catalyst C3 (respectively of catalyst C3′) such that the quantity of phosphorus introduced during this impregnation step was 0.613 (mol of P)/(mol of Mo present on the calcined C3 and dried C3′ catalytic precursors). The molar ratio of the total phosphorus over the metals, Pₜₒₜₐₗ/Mo, in the calcined C6 and dried C6′ catalysts were identical to those for the calcined C4 and C5 and dried C4′ and C5′ catalysts, i.e. equal to 0.613 (mol of P)/(mol of Mo initially present on catalytic precursor). The phosphorus precursor used was phosphoric acid dissolved in a polar solvent constituted by a 50/50 by volume water/ethanol mixture, each of the constituents of said mixture having a dielectric constant of more than 20 (the dielectric constant of water is 78.4 and the dielectric constant of ethanol is 24.5). After a maturation step of 48 h, the extrudates were dried at 120° C. for 2 h at a pressure of 100 mbar. The final renormalized metal oxide contents and the specific surface area of the catalysts C6 and C6′ were thus as follows:

| | |
|---|---|
| MoO₃: | 21.9 (% by weight); |
| CoO: | 5.0 (% by weight); |
| P₂O₅: | 4.8 (% by weight) |
| specific surface area (S_{BET}): | 200 (m²/g of catalyst), i.e. 298 m²/g of |
| | alumina in catalyst C6; |
| Pₜₒₜₐₗ/Mo | 0.613 mol/mol |

It should be noted that these catalysts C6 and C6′ had a molar ratio Pₜₒₜₐₗ/Mo identical to that of catalysts C4, C4′, C5 and C5′ with the exception that they had a larger quantity of phosphorus introduced using step a) of the process of the invention. Its specific surface area was higher than that of catalysts C5 and C5′, and clearly of catalysts C4 and C4′.

### Example

### Not in Accordance with the Invention

Catalysts C6 and C6′ were calcined in dry air at 450° C. for two hours. The catalysts obtained after calcining were respectively C9 and C9′. The final metal oxide contents and the specific surface area of catalysts C9′ and C9 (determined using the BET method which is well known to the skilled person) were thus as follows:

| | |
|---|---|
| MoO₃: | 21.4 (% by weight); |
| CoO: | 4.9 (% by weight); |
| P₂O₅: | 4.8 (% by weight) |
| specific surface area (S_{BET}): | 185 (m²/g of catalyst), i.e. 276 m²/g |
| | of alumina in catalyst C9; |
| Pₜₒₜₐₗ/Mo | 0.613 mol/mol |

It will be seen that the supplemental calcining step added to change C6 into C6′ and C9 into C9′ could not conserve the high specific surface area of catalysts C6 and C6′ in accordance with the invention since the specific surface area of catalysts C9 and C9′ was close to that of C1 and C1′.

### Example 7

### Comparative Test of Catalysts C1, C2, C3, C1′, C2′, C3′, C4, C4′, C5, C5′, C6 and C6′, C9 and C9′ in the Hydrogenation of Toluene in Cyclohexane Under Pressure and in the Presence of Hydrogen Sulphide

The catalysts described above were dynamically sulphurized in situ in the fixed traversed bed tube reactor of a Catatest type pilot unit (constructed by Gómécanique), the fluids moving from top to bottom. The hydrogenating activity measurements were carried out immediately after sulphurization under pressure and without letting in air with the hydrocarbon feed which had acted to sulphurize the catalysts.

The sulphurization and test feed was composed of 5.8% of dimethyldisulphide (DMDS), 20% of toluene and 74.2% of cyclohexane (by weight). The stabilized catalytic activities of equal volumes of catalyst were then measured in the toluene hydrogenation reaction.

The conditions for measuring the activity were as follows:

| | |
|---|---|
| total pressure: | 6.0 MPa; |
| pressure of toluene: | 0.38 MPa; |
| pressure of cyclohexane: | 1.55 MPa; |
| pressure of hydrogen: | 3.64 MPa; |
| pressure of H₂S: | 0.22 MPa; |
| volume of catalyst: | 40 cm³; |
| flow rate of feed: | 80 cm³/h; |
| hourly space velocity: | 2 h⁻¹; |
| hydrogen flow rate: | 36 l/h; |
| [symbol] | [symbol] |

[symbol]

indicates data missing or illegible when filed

Samples of the liquid effluent were analyzed by gas chromatography. Determination of the molar concentrations of unconverted toluene (T) and the concentrations of its hydrogenation products (methylcyclohexane (MCC6), ethylcyclopentane (EtCC5) and dimethylcyclopentanes (DMCC5) allowed the degree of hydrogenation of toluene, X_{HYD}, to be calculated, defined as follows:

$${X}_{HYD} ( \% ) = 100 * \frac{( MCC 6 + EtCC 5 + DMCC 5 )}{( T + MCC 6 + EtCC 5 + DMCC 5 )}$$

Since the toluene hydrogenation reaction is of the order of l^{o} under the test conditions employed and the reactor behaves as an ideal plug reactor, the hydrogenation activity A_{HYD} of the catalysts was calculated using the formula:

A_{HYD}=ln(100/(100−X_{HYD}))

Table 1 compares the relative hydrogenating activities of said catalysts, equal to the ratio of the activity of the catalyst under consideration over the activity of catalyst C3, not in accordance with the invention, and taken as the reference (100% activity).

TABLE 1
Relative activities for the hydrogenation of calcined catalysts

| | | Proportion of | | | | |
|---|---|---|---|---|---|---|
| | | P added in | | | | |
| | | step a) of | | S_{BET} | | |
| | | inventive | | (m²/g of | | |
| | | process with | S_{BET} | alumina | Relative | Gain over |
| | Formulation | respect to total | (m²/g of | in | A_{HYD} with | starting |
| | CoO/MoO₃/P₂O₅ | quantity of P | catalyst) | catalyst) | respect to C3 | catalyst |
| C1 | 4.1/23.4/4.6 | 0 | 180 | 273 | 130 | — |
| C2 | 4.0/23.3/2.0 | 0 | 203 | 287 | 112 | — |
| C3 | 5.3/23 | 0 | 214 | 298 | 100 | — |
| | | | | | (reference) | |
| C4 | 4.1/23.3/5.1 | 8% | 179 | 273 | 138 | 6% with |
| | | | | | | respect to |
| | | | | | | C1 |
| C5 | 3.9/22.6/5.0 | 71% | 193 | 287 | 144 | 29% with |
| | | | | | | respect to |
| | | | | | | C2 |
| C6 | 5.0/21.9/4.8 | 100% | 200 | 298 | 145 | 45% with |
| | | | | | | respect to |
| | | | | | | C3 |
| C9 | 4.9/21.4/4.8 | 100% | 185 | 276 | 109 | 9% gain |
| | | | | | | with respect |
| | | | | | | to C3 and |
| | | | | | | 25% loss of |
| | | | | | | activity with |
| | | | | | | respect to |
| | | | | | | C6 |

Table 1 shows the large gain in activity obtained with the catalysts prepared using the process of the invention over the reference calcined catalysts, which were not in accordance with the invention, wherein all of the phosphorus had been deposited on the catalyst in the impregnation solution. The gains here are even larger when the proportion of phosphorus introduced in accordance with the invention compared with the total phosphorus is raised.

Table 1 also shows that the specific surface area, calculated in m² per gram of alumina, does not reduce between the starting catalytic precursor and the final catalyst obtained by the process of the invention. This remains constant.

It will be noted that subsequent calcining of catalyst C6 to obtain a catalyst C9 which was not in accordance with the invention resulted in a loss of the benefit of the invention, i.e. a loss of surface area, poor dispersion and a loss of activity.

In the same manner, Table 2 compares the relative hydrogenating activities of the dried catalysts, also with respect to the activity of the catalyst under consideration over the activity of catalyst C3′, not in accordance with the invention and taken as the reference (100% activity).

Surprisingly, although the catalysts initially contain phosphorus and they have never undergone calcining, Table 2 shows the large gain in activity obtained for the dried catalysts prepared using the process of the invention over reference dried catalysts, which were not in accordance with the invention, wherein all of the phosphorus had been deposited on the catalyst in the impregnation solution. It should be noted that the gain in terms of activity is higher when the invention is applied to the dried catalysts rather than to the calcined catalysts.

It will be noted that subsequent calcining of catalyst C6′ (not in accordance with the invention) resulted in a loss of the benefit of the invention (loss of surface area, poor dispersion and loss of activity for C9′)

TABLE 2
Relative activities for the hydrogenation of dried catalysts

| | | Relative | |
|---|---|---|---|
| | Formulation | A_{HYD} with | Gain over |
| | CoO/MoO₃/P₂O₅ | respect to C3 | starting catalyst |
| C1′ | 4.1/23.4/4.6 | 123 | — |
| C2′ | 4.0/23.3/2.0 | 105 | — |
| C3′ | 5.3/23 | 100 (reference) | — |
| C4′ | 4.1/23.3/5.1 | 148 | 12% with respect to C1′ |
| C5′ | 3.9/22.6/5.0 | 154 | 46% with respect to C2′ |
| C6′ | 5.0/21.9/4.8 | 153 | 53% with respect to C3′ |
| C9′ | 4.9/21.4/4.8 | 105 | 5% gain with respect to C3′. |
| | | | 31% loss of activity with |
| | | | respect to C6′ |

### Example 8

### Preparation of a Calcined Catalyst C7 and of a Dried Catalyst C7′ of the NiMoP Type (not in Accordance with the Invention)

Dried catalyst C7′ and its calcined version C7 were prepared in the same manner as their homologous C1′ and C1, with the exception that the cobalt hydroxide was replaced by nickel hydroxycarbonate. The quantities of precursors were as follows: 68.2 g of shaped alumina, 24.02 g of molybdenum trioxide, 11.19 g of nickel hydroxycarbonate and 7.47 g of phosphoric acid.

The final oxide contents of the metals and the specific surface area of catalysts C7 and C7′ were thus as follows:

| | |
|---|---|
| MoO₃: | 23.1 (% by weight); |
| NiO: | 4.1 (% by weight); |
| P₂O₅: | 4.6 (% by weight); |
| specific surface area (S_{BET}): | 191 (m²/g of catalyst), i.e. 282 m²/g of |
| | alumina in catalyst C7. |

### Example 9

### Preparation of a Catalyst C8 and a Catalyst C8′ of the Nimop Type by Impregnation of Calcined Catalyst C7 and Dried Catalyst C7′ Respectively (in Accordance with the Invention)

Catalyst C8 (respectively catalyst C8′) was obtained by impregnation of the calcined NiMoP catalyst C7 (respectively of dried catalyst C7′) such that the quantity of phosphorus introduced during this impregnation step in accordance with step a) of the process of the invention was 0.05 mol of P/mol of Mo present on the catalyst. The phosphorus precursor used was phosphoric acid and the solvent selected in accordance with “Solvents and Solvent Effects in Organic Chemistry”, C Reichardt, Wiley-VCH, 3^{rd} edition, 2003, pages 472-474 was DMSO with a dielectric constant of 46. After a maturation step of 48 h, the extrudates were dried at 120° C. for 2 h at a pressure of 100 mbar. The final metal oxide contents and the specific surface area of the catalysts C8 and C8′ were thus as follows:

| | |
|---|---|
| MoO₃: | 23.0 (% by weight); |
| CoO: | 4.1 (% by weight); |
| P₂O₅: | 5.1 (% by weight) |
| specific surface area | 190 (m²/g of catalyst), i.e. 282 m²/g |
| (S_{BET}): | of alumina in catalyst C8. |

### Example 10

### Comparative Test for Hydrodesulphurization of a Gas Oil of Catalysts C7, C8 and C7′, C8′

Catalysts C7, C7′, C8 and C8′ described above were also compared in a hydrodesulphurization test for a gas oil the principal characteristics of which are given below:

| | |
|---|---|
| density at 15° C.: | 0.8522 |
| sulphur: | 1.44% by weight |
| simulated distillation: | |
| IP | 155° C. |
| 10% | 247° C. |
| 50% | 315° C. |
| 90% | 392° C. |
| EP | 444° C. |

The test was carried out in a traversed fixed bed isothermal pilot reactor with the fluids moving from bottom to top. After in situ sulphurization at 350° C. in the unit under pressure using the test gas oil supplemented with 2% by weight of dimethyldisulphide, the hydrodesulphurization test was carried out under the following operating conditions:

| | | |
|---|---|---|
| total pressure: | 7 | MPa |
| volume of catalyst: | 30 | cm³ |
| temperature: | 340° | C. |
| hydrogen flow rate: | 24 | l/h |
| feed flow rate: | 60 | cm³/h |

The catalytic performances of the test catalysts are given in Table 3. They are expressed as the relative activity, assuming that that of calcined catalyst C7 was equal to 100 and considering it to be of order 1.5. The relationship linking the activity and conversion in hydrodesulphurization (% HDS) is as follows:

A_{HDS}=100/([(100−HDS)]^{0.5})−1

TABLE 3
Relative activity at iso-volume of catalysts C7, not in accordance,
and C8, in accordance, for gas oil hydrodesulphurization

| | | S_{BET} (m²/g of | |
|---|---|---|---|
| | S_{BET} (m²/g of | alumina present in | |
| Catalyst | catalyst) | catalyst) | A_{HDS} relative to C7 |
| C7 | 191 | 282 | 100 |
| C8 | 190 | 282 | 145 |

Table 3 shows the large gain in activity obtained with CoMo catalysts can also be extrapolated to NiMo catalysts for gas oil HDS. The catalytic performances of the tested catalysts C7′ and C8′ are given in Table 4, the dried catalyst C7′ being the reference catalyst.

Further, Table 3 also shows that the specific surface area, calculated in m² per gram of alumina, is not reduced between the starting calcined catalytic precursor C7 and the final catalyst C8 obtained by the process of the invention. On the contrary, this remained constant.

TABLE 4
Relative activity at iso-volume of catalysts C7′, not in accordance,
and C8′, in accordance, for gas oil hydrodesulphurization

| Catalyst | A_{HDS} relative to C7′ |
|---|---|
| C7′ | 100 |
| C8′ | 155 |

Table 4 shows that the large gain in activity obtained for CoMo catalysts can also be extrapolated to NiMo catalysts in gas oil HDS.

### Example 11

### Hydrotreatment Test of a Vacuum Distillate

Catalysts C7 and C8 described above were also compared in a hydrodesulphurization test for a vacuum distillate the principal characteristics of which are given below:

| | |
|---|---|
| density at 20° C.: | 0.9365 |
| sulphur: | 2.92% by weight |
| total nitrogen: | 1400 ppm by weight |
| simulated distillation: | |
| IP | 361° C. |
| 10% | 430° C. |
| 50% | 492° C. |
| 90% | 567° C. |
| EP | 598° C. |

The test was carried out in a traversed fixed bed isothermal pilot reactor with the fluids moving from bottom to top. After in situ sulphurization at 350° C. in the unit under pressure using a straight run gas oil supplemented with 2% by weight of dimethyldisulphide, the hydrotreatment test was carried out under the following operating conditions:

| | | |
|---|---|---|
| total pressure: | 12 | MPa |
| volume of catalyst: | 40 | cm³ |
| temperature: | 380° | C. |
| hydrogen flow rate: | 40 | l/h |
| feed flow rate: | 40 | cm³/h |

The catalytic performances of the test catalysts are given in Table 5 below. They are expressed as the relative activity, assuming that that of calcined catalyst C7 was equal to 100 and considering it to be of order 1.5. The relationship linking the activity and conversion in hydrodesulphurization (% HDS) is as follows:

A_{HDS}=100/([(100−% HDS)]^{0.5})−1

The same relationship is applicable for hydrodenitrogenation (% HDN and A_{HDN}).

Further, the gross conversion of a fraction with a boiling point of less than 380° C. obtained with each catalyst was evaluated. It was expressed using the simulated distillation results (ASTM D86 method) using the relationship:

Conversion=(%380⁺feed−%380⁻effluent)/%380⁺feed

TABLE 5
Activity of catalysts C7, not in accordance, and C8, in accordance,
for vacuum distillate hydrotreatment

| | A_{HDS} relative | A_{HDN} relative | Conversion |
|---|---|---|---|
| Catalyst | to C7 | to C7 | 380° C.⁻ (%) |
| C7 | 100 | 100 | 25 |
| C8 | 135 | 145 | 29 |

Table 6 shows the large gain in activity obtained for the catalyst prepared in accordance with the invention compared with the reference catalyst.

### Example 12

### Preparation of a Calcined Catalyst C9 of the Como Type (not in Accordance with the Invention)

Catalyst C9 was prepared in the same manner as calcined catalyst C3, using the same impregnation solution but diluted by a factor of 1.35. The final quantities of metal oxides and the specific surface area of the calcined catalyst C9 were thus as follows:

| | |
|---|---|
| MoO₃: | 17.0 (% by weight); |
| CoO: | 3.9 (% by weight); |
| specific surface area (S_{BET}): | 231 m²/g; |

### Example 13

### Preparation of a Catalyst C10 of the Como Type by Impregnation of Calcined Catalyst C9 (in Accordance with the Invention)

Catalyst C10 was obtained by impregnation of the calcined catalyst C9 such that the quantitv of phosphorus introduced during this impregnation step was 0.015 (mol of P)/(mol of Mo) present on the catalyst. The phosphorus precursor used was phosphoric acid and the solvent selected in accordance with “Solvents and Solvent Effects in Organic Chemistry”, C Reichardt, Wiley-VCH, 3^{rd} edition, 2003, pages 472-474 was methanol with a dielectric constant of 33. After a maturation step of 96 h, the extrudates were dried at 120° C. for 2 h at a pressure of 100 mbar. The final metal oxide contents and the specific surface area of the catalyst C10 were thus as follows:

| | | |
|---|---|---|
| MoO₃: | 16.8 | (% by weight); |
| CoO: | 3.9 | (% by weight); |
| P₂O₅: | 1.0 | (% by weight) |
| specific surface area (S_{BET}): | 228 | m²/g. |

### Example 14

### Comparative Test in Selective Hydrodesulphurization of a Model Fcc Gasoline Type Feed

Catalysts C9 (not in accordance) and C10 (in accordance) described above were tested in a reaction for selective desulphurization of a model FCC gas type feed. The test was carried out in a Grignard type (batch) reactor at 200° C. at a pressure of 3.5 MPa in hydrogen, maintained constant. The model feed was constituted by 1000 ppm of 3-methylthiophene and 10% by weight of 2,3-dimethyl-but-2-ene in n-heptane. The volume of the cold solution was 210 cm³; the mass of the test catalyst was 4 grams (before sulphurization). Before the test, the catalyst was pre-sulphurized in a sulphurization unit in a mixture of H₂S/H₂ (4 l/h, 15% by volume of H₂S) at 400° C. for two hours (ramp-up 5° C./min) then reduced in pure H₂ at 200° C. for two hours. The catalyst was then transferred to the air-excluded Grignard reactor.

The rate constant (normalized per g of catalyst) was calculated by assuming first order for the desulphurization reaction (k_{HDS}) and zero order for the hydrogenation reaction (k_{HDO}). The selectivity of a catalyst is defined as the ratio of its rate constants, k_{HDS}/k_{HDO}. The relative rate constants for catalysts C9 and C10 and their selectivity are reported in Table 6 below.

TABLE 6
Relative rate constants and selectivity of catalysts C9
(not in accordance) and C10 (in accordance)

| Catalyst | K_{HDS} | K_{HDO} | K_{HDS}/k_{HDO} |
|---|---|---|---|
| C9 | 1.0 | 2.32 | 0.43 |
| C10 | 1.3 | 2.34 | 0.56 |

It transpires that catalyst C10 in accordance with the invention is both more active in desulphurization and more selective than the calcined catalyst C9 (not in accordance).

### Example 15

### Preparation of a Calcined Catalyst C11 and Dried Catalyst C11′, not in Accordance with the Invention

Dried catalyst C11′, not in accordance with the invention, was prepared by impregnation of the dried catalyst C2′ using a control solution containing no phosphorus-containing compound. The solvent selected in accordance with “Solvents and Solvent Effects in Organic Chemistry”, C Reichardt, Wiley-VCH, 3^{rd} edition, 2003, pages 472-474 was 1,2-ethanediol with a dielectric constant of 38.

Catalyst C11 was a control catalyst prepared in the same manner from calcined catalyst C2.

### Example 15

### Preparation of a Catalyst C12 and Catalyst C12′ by Respective Impregnation of Calcined Catalyst C2 and Dried Catalyst C2′ (in Accordance with the Invention)

Catalyst C12′ was prepared in a manner which was in accordance with the invention by impregnation with a solution containing 0.275 mole of phosphorus per mole of molybdenum present on the calcined catalyst C2. The phosphorus compound selected was phosphoric acid. The solvent selected in accordance with “Solvents and Solvent Effects in Organic Chemistry”, C Reichardt, Wiley-VCH, 3^{rd} edition, 2003, pages 472-474 was also 1,2-ethanediol with a dielectric constant of 38. The final metal oxide contents and the specific surface area of the catalyst C12 were thus as follows:

| | |
|---|---|
| MoO₃: | 22.6 (% by weight); |
| CoO: | 3.9 (% by weight); |
| P₂O₅: | 5.0 (% by weight) |
| specific surface area (S_{BET}): | 197 m²/g, i.e. 288 m²/g of alumina |
| | contained in C12. |

### Example 16

### Preparation of a Catalyst C13′, not in Accordance with the Invention

Catalyst C13′ was prepared by impregnation with a solution containing 0.275 mole of phosphorus per mole of molybdenum present on the catalyst C2′. The phosphorus-containing compound selected was phosphoric acid. The solvent was selected in accordance with “Solvents and Solvent Effects in Organic Chemistry”, C Reichardt, Wiley-VCH, 3^{rd} edition, 2003, pages 472-474 and was diethylene glycol diethyl ether with a dielectric constant of 5.7. This solvent was very slightly polar and thus was not in accordance with the invention. The final metal oxide contents, recalculated for the loss on ignition of the dried catalyst, were thus as follows:

| | |
|---|---|
| MoO₃: | 22.5 (% by weight); |
| CoO: | 3.8 (% by weight); |
| P₂O₅: | 5.1 (% by weight) |

### Example 17

### Comparative Test in Hydrodesulphurization of a Gas Oil of Catalysts C2 (Respectively C2′) (not in Accordance), C11 (Respectively C11′) (not in Accordance), C12 (Respectively C12′) (in Accordance) and C13′ (not in Accordance)

Catalysts C2, C2′ (not in accordance), C11, C11′ (not in accordance), C12, C12′ (in accordance), C13′ (not in accordance) described above were also compared in a hydrodesulphurization test of a gas oil the principal characteristics of which were described in Example 10 of this document.

TABLE 7
Relative activity at iso-volume of catalysts in
gas oil hydrodesulphurization

| Catalyst | A_{HDS} relative to C2 |
|---|---|
| C11, not in accordance | 115 |
| C12, in accordance | 145 |

Table 7 shows that the large gain in activity obtained for CoMoP catalysts is clearly linked to the presence of the phosphorus-containing compound introduced in accordance with impregnation step a) of the process of the invention.

The catalytic performances of catalysts C11′, C12′ and C13′ are given in Table 8, catalyst C7, being the reference catalyst.

TABLE 8
Relative activity at iso-volume of catalysts C11′, C12′ and
C13′ in gas oil hydrodesulphurization

| Catalyst | A_{HDS} relative to C7′ |
|---|---|
| C11′, not in accordance | 135 |
| C12′, in accordance | 175 |
| C13′, not in accordance | 97 |

Surprisingly, Table 5 shows that while the starting catalysts contain phosphorus which has never undergone calcining, a large gain in activity is clearly obtained by adding phosphorus in a polar solvent with a dielectric constant of more than 20, like 1,2-ethanediol in an impregnation step in accordance with step a) of the process of the invention.

The gain observed for catalyst C11′, not in accordance with the invention, impregnated with a solution containing no phosphorus-containing compound is less. Further, no gain in activity was obtained by adding phosphoric acid dissolved in a very slightly polar solvent such as diethylene glycol diethyl ether.

1. A process for preparing a hydrotreatment catalyst, comprising the following steps:
a) at least one step for impregnation of a dried and/or calcined catalytic precursor containing at least one element from group VIII and/or at least one element from group VIB and an amorphous support, using an impregnation solution constituted by at least one phosphorus-containing compound in solution in at least one polar solvent with a dielectric constant of more than 20;
b) a step for maturing said impregnated catalytic precursor from step a), said maturation step b) being carried out at atmospheric pressure, at a temperature in the range from ambient temperature to 60° C. and for a maturation period in the range 12 hours to 340 hours;
c) a step for drying, without a subsequent calcining step, said catalytic precursor from step b).

2. A preparation process according to claim 1, in which said dried catalytic precursor contains at least one element from group VIII, said element from group VIII being cobalt, and at least one element from group VIB, said element from group VIB being molybdenum, with phosphorus as the dopant, and an amorphous alumina support.

3. A preparation process according to claim 1, in which said dried catalytic precursor contains at least one element from group VIII, said element from group VIII being nickel, and at least one element from group VIB, said element from group VIB being molybdenum, with phosphorus as the dopant, and an amorphous alumina support.

4. A preparation process according to claim 1, in which the phosphorus-containing compound of the impregnation solution of step a) is selected from the group formed by orthophosphoric acid H₃PO₄, metaphosphoric acid and phosphorus pentoxide or phosphoric anhydride P₂O₅, or P₄O₁₀, used alone or as a mixture.

5. A preparation process according to claim 4, in which the phosphorus-containing compound of the impregnation solution of step a) is orthophosphoric acid, H₃PO₄.

6. A preparation process according to claim 1, in which said phosphorus-containing compound is introduced into the impregnation solution in a quantity corresponding to a molar ratio of phosphorus P over group VIB metal (metals) of said catalytic precursor in the range 0.001 to 3 mole/mole.

7. A preparation process according to claim 6, in which said phosphorus-containing compound is introduced into the impregnation solution in a quantity corresponding to a molar ratio of phosphorus P over group VIB metal (metals) of said catalytic precursor in the range 0.01 to 1 mole/mole.

8. A preparation process according to claim 1, in which step a) is a single dry impregnation step.

9. A preparation process according to claim 1, in which the impregnation solution of step a) is constituted by a single phosphorus-containing compound in solution in a single polar solvent with a dielectric constant of more than 24.

10. A preparation process according to claim 1, in which the impregnation solution of step a) is constituted by a single phosphorus-containing compound in solution in two polar solvents, each of the two polar solvents having a dielectric constant of more than 24.

11. A preparation process according to claim 1, in which said polar solvent is selected from the group of polar protic solvents selected from methanol, ethanol, water, phenol, cyclohexanol and 1,2-ethanediol, used alone or as a mixture.

12. A preparation process according to claim 1, in which said polar solvent is selected from the group formed by propylene carbonate, DMSO (dimethylsulphoxide) and sulpholane, alone or as a mixture.

13. A preparation process according to claim 1, in which the drying step c) is carried out in a furnace at atmospheric pressure or at reduced pressure and at a temperature in the range 50° C. to 200° C.

14. In the catalytic hydrorefining and hydroconversion of hydrocarbon feeds the improvement wherein the feeds are reacting in contact with the catalyst of claim 1.

15. A process according to claim 14 for the reactions of hydrogenation, hydrodenitrogenation, hydrodeoxygenation, hydrodearomatization, hydrodesulphurization, hydrodemetallization and hydroconversion of hydrocarbon feeds containing aromatic and/or olefinic and/or naphthenic and/or paraffinic compounds.
